(19) United States
(12) Patent Application Publication
(10) Pub. No.: US 2014/0190535 A1
(43) Pub. Date: Jul. 10, 2014

(54) ADJUSTABLE GAIT TRAINER BARS

(71) Applicant: George E. Antoun, Brooklyn, NY (US)

(72) Inventor: George E. Antoun, Brooklyn, NY (US)

(21) Appl. No.: 13/920,086

(22) Filed: Jun. 18, 2013

Related U.S. Application Data
(60) Provisional application No. 61/750,311, filed on Jan. 8, 2013.

(51) Int. Cl. A61H 3/00

(52) U.S. Cl. CPC A61H 3/00
USPC 135/66

(57) ABSTRACT

An adjustable gait trainer bar that includes a telescoping stem with a first end, a second end, a first portion and a second portion and a joint clamp coupled to the first end of the stem, the joint clamp includes a clamp, a first lock clip, a first joint lock and a first threaded aperture. The adjustable gait trainer bar also includes a joint claw coupled to the second end of the stem, the second push button locking clip includes a claw, a second lock clip, a second joint lock, and a second threaded aperture and a fastener configured to selectively extend through a first respective aperture of the first portion and an aperture of the second portion, whereby to selectively position a length of the telescoping stem.

This application claims priority to U.S. Provisional Application 61/750,311 filed on Jan. 8, 2013, the entire disclosure of which is incorporated by reference.

### BACKGROUND OF THE INVENTION

1. Field of the Invention

The present invention is a plurality of adjustable bars. More specifically, the present invention is a plurality of adjustable gait trainer bars.

2. Description of the Related Art

Gait training is accomplishment by having the patient walk while holding onto two adjustable parallel bars or using an assisted device such as a rolling walker or a standard walker. Even with the support of the bars and trained professionals nearby, these patients can unexpectedly fall with devastating results. Their knees can buckle unexpectedly and they can fall even with an attendant close behind their wheelchair. They can turn quickly losing their balance and may fall even with a walker nearby. In these cases the wheelchair is too far behind to catch the falling patient or the patient is unable to control their walker. Many of these patients may have had recent orthopedic surgeries or suffered strokes and other neurological or neuromuscular injuries. Our society is always seeking new and better ways to help rehabilitate physically impaired patients and provide needed safety when helping patients regain their ability to walk.

### BRIEF SUMMARY OF THE INVENTION

The present invention is a plurality of adjustable bars. More specifically, the present invention is a plurality of adjustable gait trainer bars.

The adjustable gait trainer bar includes a telescoping stem with a first end, a second end, a first portion and a second portion and a joint clamp coupled to the first end of the stem, the joint clamp includes a clamp (which attach to a rolling walker or a wheelchair), a first lock clip, a first joint lock, and a first threaded aperture. The adjustable gait trainer bar also includes a joint claw coupled to the second end of the stem, the joint claw includes a claw (which attach to a standard walker), a second lock clip, a second joint lock, and a second threaded aperture and a fastener configured to selectively extend through a first respective aperture of the first portion and an aperture of the second portion, whereby to selectively position a length of the telescoping stem.

It is an object of the present invention to provide a plurality of adjustable gait trainer bars that provides for safe gait training by decreasing the risk of debilitating falls and more stability during gait training in a rehabilitation setting.

It is an object of the present invention to provide a plurality of adjustable gait trainer bars that improves the efficiency of the staff and allows for a more economical use of time and effort as staff will be able to allow patients to practice walking more independently and without needing someone to follow the patient with a wheelchair during ambulation.

It is an object of the present invention to provide a plurality of adjustable gait trainer bars that decreases the risks of injuries of health care worker staff and patients.

It is an object of the present invention to provide a plurality of adjustable gait trainer bars that the walker or wheelchair remains within an appropriate distance from the patient.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead exploded view of a plurality of adjustable gait trainer bars, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

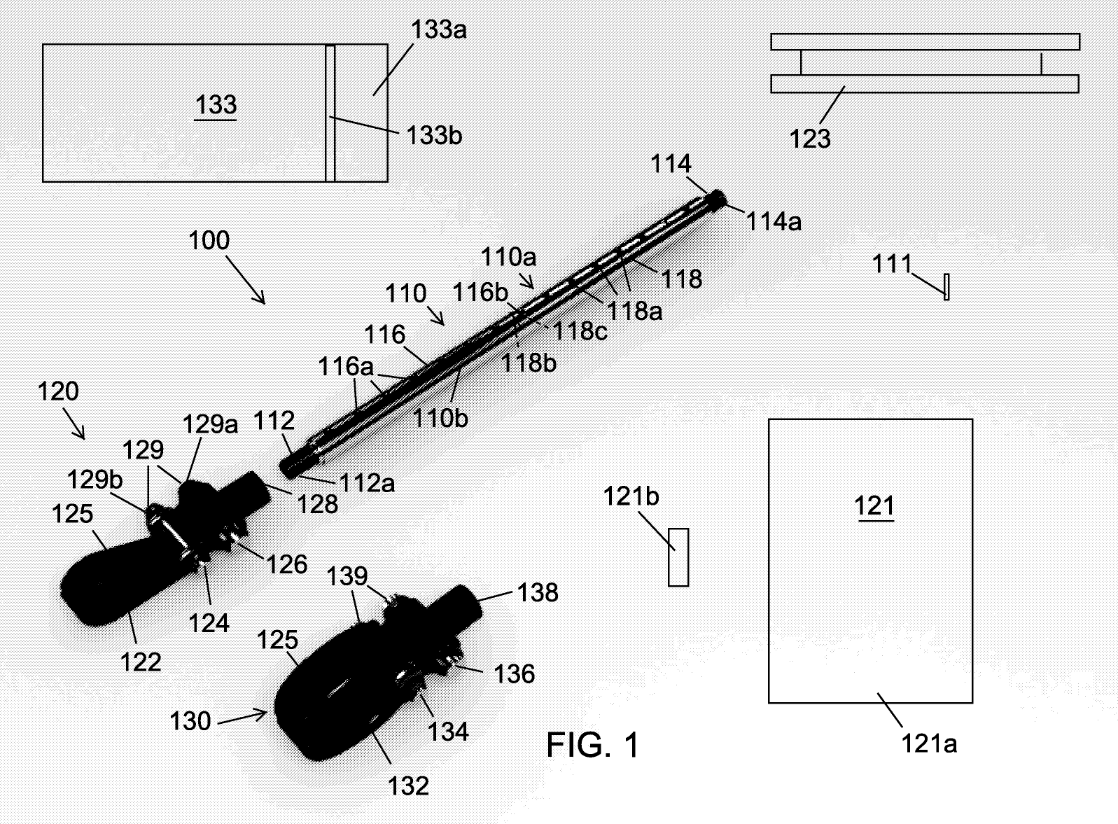

FIG. 1 illustrates an overhead exploded perspective view of a plurality of adjustable gait trainer bars 100, in accordance with one embodiment of the present invention.

The adjustable gait trainer bars 100 include a stem 110, a joint clamp 120 and a joint claw 130.

The stem 110 includes a first end 112, a second end 114, a first portion 116 and a second portion 118. The stem 110 can be a telescoping stem 110a or any other suitable type of stem. The first end 112 has a first male threading 112a and the second end 114 has a second male threading 114a. The first portion 116 defines a plurality of first apertures 116a. The second portion 118 defines a plurality of second apertures 118a and a hollow interior area 118b configured to slidably and selectively receive the first portion 116. The second portion 118 defines an aperture 118c positioned to register with a first respective aperture 116b of the first portion 116. A fastener 111 is configured to selectively extend through a first respective aperture 116b of the first portion 116 and the aperture 118c of the second portion 118, whereby to selectively position a length 110b of the stem 110.

The joint clamp 120 includes a clamp 122, a first lock clip 124, a first joint lock 126, a first threaded aperture 128 and a first pair of push buttons 129. The first push button 129b of the pair of push buttons 129 locks the clamp 122 the second push button 129a of the pair of push buttons 129 allows rotation approximately 90 degrees right and left or locked into a position that is parallel to a floor according to the patient needs and safety. The clamp 122 couples to a backend 121a of a walker 121 or a hook and loop fastener 121b or VELCRO™ fastener coupled to a pair of parallel bars 123. The first joint lock 124 locks the clamp 122 in a locked position. The first threaded aperture 128 receives the first male threading 112a of the first end 112 of the stem 110 to couple the first push button locking clip 120 to the first male threading 112a of the first end 112 of the stem 110.

The joint claw 130 includes a claw 132, a second clip lock 134, a second joint lock 136, a second threaded aperture 138 and a second pair of push buttons 139. The second joint lock 136 locks the claw 132 in a locked position with no rotation or 90 degree rotation to the right and the left according to the patient needs and safety. The second lock clip 134 is coupled to the joint lock 136 and the claw 132 and allows the second joint lock 136 to lock the claw 132. The second threaded aperture 138 receives the second male threading 114a of the second end 114 of the stem 110 to couple the second push button locking clip 130 to the second male threading 114a of the second end 114 of the stem 110. FIG. 1 illustrates the joint clamp 120 and the joint claw 130 in a closed position 125.

In use, the adjustable gait trainer bars are utilized for safe gait training and are utilized in pairs in conjunction with parallel bars which support the patient and provide more stability as a patient practices walking. Each end of the adjustable gait trainer bar has a push button clip. One push button clip is coupled to the front of a wheelchair or its footrest. The other push button clip is coupled to the back end of a walker or a hook and loop belt, which then links to the parallel bars. Between the adjustable gait trainer bar and the locking clip is a push button joint that allows rotation approximately 90 degrees right or left, which may be necessary so that when the adjustable gait trainer bar is coupled to the wheelchair and the walker, it can be locked into a position that is parallel to the floor. The push button joint allows flexibility or stability according to the patient's needs.

The adjustable gait trainer bar is adjustable in length. The purpose of the adjustable gait trainer bar is to create a safe distance between the patient and the wheelchair during ambulation with the walker or the inside of the parallel bars, but keeping it close enough to provide support to the patient if the patient begins to fall. The patient is allowed just enough room for their feet to freely move with the wheelchair close behind or the walker within easy reach. Should the patient need the extra support to remain upright, the walker is just ahead of him at all times or if the patient falls or has a buckling knee, the wheelchair is right behind the patient to catch the patient before a serious fall happens.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An adjustable gait trainer bar, comprising:
a stem including a first end, a second end, a first portion and a second portion;
a joint clamp coupled to the first end of the stem, the joint clamp includes a clamp, a first lock clip, a first joint lock, a first threaded aperture and a first pair of push buttons; and
a joint claw coupled to the second end of the stem, the joint claw includes a claw, a second lock clip, a second joint lock, a second threaded aperture and a second pair of push buttons.

2. The adjustable gait trainer bar according to claim 1, wherein the clamp couples to a backend of a rolling walker and a wheelchair.

3. The adjustable gait trainer bar according to claim 2, wherein the joint clamp or the joint claw is coupled to an upper part of a footrest of the wheelchair or one or more front bars of the wheelchair.

4. The adjustable gait trainer bar according to claim 1, wherein the clamp couples to a hook and loop fastener coupled to a pair of parallel bars.

5. The adjustable gait trainer bar according to claim 1, wherein the first joint lock locks the clamp in a locked position.

6. The adjustable gait trainer bar according to claim 5, wherein the first lock clip is coupled to the joint lock and the clamp and allows the first joint lock to lock the clamp in the locked position.

7. The adjustable gait trainer bar according to claim 1, wherein the claw couples to a front of a standard walker.

8. An adjustable gait trainer bar, comprising:
a telescoping stem including a first end, a second end, a first portion and a second portion, wherein the first portion defines a plurality of first apertures, the second portion defines a plurality of second apertures and a hollow interior area configured to slidably and selectively receive the first portion and the second portion defines an aperture positioned to register with a first respective aperture of the first portion;
a joint clamp coupled to the first end of the stem, the joint clamp includes a clamp, a first lock clip, a first joint lock, a first threaded aperture and a first pair of push buttons, the first push button locking clip allows rotation approximately 90 degrees right or left and is locked into a position that is parallel to a floor, the first threaded aperture receives the first male threading of the first end of the stem to couple the first push button locking clip to the first male threading of the first end of the stem;
a joint claw coupled to the second end of the stem, the joint claw includes a claw, a second lock clip, a second joint lock, a second threaded aperture and a second pair of push buttons, the second lock clip is coupled to the second joint lock and the clamp and the second threaded aperture receives the second male threading of the second end of the stem to couple the second joint claw to the second male threading of the second end of the stem; and
a fastener configured to selectively extend through a first respective aperture of the first portion and the aperture of the second portion, whereby to selectively position a length of the telescoping stem.

9. The adjustable gait trainer bar according to claim 8, wherein the joint clamp or the joint claw is coupled to a backend of a walker.

10. The adjustable gait trainer bar according to claim 9, wherein the clamp couples to the backend of the walker and a footrest of the wheelchair.

11. The adjustable gait trainer bar according to claim 8, wherein the clamp couples to a hook and loop fastener coupled to a pair of parallel bars.

12. The adjustable gait trainer bar according to claim 8, wherein the first joint lock locks the clamp in a locked position.

13. The adjustable gait trainer bar according to claim 8, wherein the first lock clip is coupled to the first joint lock and the clamp.

14. The adjustable gait trainer bar according to claim 8, wherein the second lock clip is coupled to the second joint lock and the claw.

15. The adjustable gait trainer bar according to claim 8, wherein the claw couples to a front of a standard walker.

16. An adjustable gait trainer bar, comprising:
a telescoping stem including a first end, a second end, a first portion and a second portion, wherein the first portion defines a plurality of first apertures, the second portion defines a plurality of second apertures and a hollow interior area configured to slidably and selectively receive the first portion, the second portion defines an aperture positioned to register with a first respective aperture of the first portion;
a joint clamp coupled to the first end of the stem, the joint clamp includes a clamp, a first lock clip, a first joint lock, a first threaded aperture and a first pair of push buttons, the first push button locking clip allows rotation approximately 90 degrees right or left and is locked into a position that is parallel to a floor, the first joint lock locks the clamp in a locked position, the first lock clip is coupled to the first joint lock and the clamp and allows the first joint lock to lock the clamp in the locked position, the first lock clip is coupled to the first joint lock and the clamp and the first threaded aperture receives the first male threading of the first end of the stem to couple the first push button locking clip to the first male threading of the first end of the stem;
a joint claw coupled to the second end of the stem, the joint claw includes a claw, a second joint lock, a second lock clip, a second threaded aperture and a second pair of push buttons, the second lock clip is coupled to the second joint lock and the claw, the second lock clip is coupled to the second joint lock and allows the second joint lock to lock the claw in a locked position and the second threaded aperture receives the second male threading of the second end of the stem to couple the second push button joint lock to the second male threading of the second end of the stem; and
a fastener configured to selectively extend through a first respective aperture of the first portion and the aperture of the second portion, whereby to selectively position a length of the telescoping stem.

17. The adjustable gait trainer bar according to claim 16, wherein the clamp couples to a backend of a rolling walker.

18. The adjustable gait trainer bar according to claim 16, wherein the clamp couples to a hook and loop fastener coupled to a pair of parallel bars.

19. The adjustable gait trainer bar according to claim 16, wherein the claw couples to a front of a standard walker.

20. The adjustable gait trainer bar according to claim 16, wherein the clamp couples to a footrest of a wheelchair or front leg bars of the wheelchair.
